(19) United States
(12) Patent Application Publication
(10) Pub. No.: US 2013/0162518 A1
(43) Pub. Date: Jun. 27, 2013

(54) Interactive Video System

(71) Applicants: Meghan Jennifer Athavale, Winnipeg (CA); Curtis Franz Wachs, Winnipeg (CA); Matthew Tristan Gillies, Winnipeg (CA)

(72) Inventors: Meghan Jennifer Athavale, Winnipeg (CA); Curtis Franz Wachs, Winnipeg (CA); Matthew Tristan Gillies, Winnipeg (CA)

(21) Appl. No.: 13/336,363

(22) Filed: Dec. 23, 2011

(51) Int. Cl. G09G 5/00

(52) U.S. Cl. 345/156

(57) ABSTRACT

An interactive video system includes an image capturing device, for example a video camera, for capturing user motion, and a graphical display which is arranged to be altered in response to detection of user motion as captured by the image capturing device. A user interface is arranged to display a visual representation of the motion detected by the system to assist in calibrating the system in relation to a surrounding environment.

### FIELD OF THE INVENTION

The present invention relates to an interactive video system including a camera for capturing user motion and a graphical display which is arranged to be altered in response to detection of user motion as captured by the camera, and more particularly the present invention relates to a user interface arranged to display a visual representation of the motion detected by the system to assist in calibrating the system in relation to a surrounding environment.

### BACKGROUND

Use of interactive display surfaces are known in various forms for entertainment, promotion, education and the like. A typical interactive display surface generally comprises a graphical display such as a video screen to display a graphical image or a surface onto which the graphical image may be projected for display to users within an adjacent environment, together with a system for detecting motion of the users within the adjacent environment. The motion detecting system typically relies on a suitable camera directed towards the adjacent environment and a motion detecting algorithm which analyzes the data captured by the camera to determine what type of motion has occurred. The graphical image can then be varied according to various characteristics of the detected motion. For example an object displayed in the graphical image may be displaced or varied in size, color, or configuration, etc. according to the location or amount of motion detected.

Various examples of interactive display surfaces are described in U.S. Pat. Nos. 7,834,846, 7,259,747, and 7,809,167 all by Bell; U.S. Pat. No. 7,775,883 by Smoot et al; and U.S. Pat. No. 5,534,917 by MacDougall.

All known commercial interactive display surfaces are typically generated by systems which are configured for a dedicated environment due to the complexity of calibrating the system to the conditions of the environment such as camera placement, video display placement, size of the environment, lighting conditions and the like. The calibration of the known systems to their environment is therefore generally required to be performed by programmers having considerable knowledge about the system. The installation of known systems is thus generally considered to be very costly and unable to be performed by persons who are not experts in the field.

### SUMMARY OF THE INVENTION

According to one aspect of the invention there is provided an interactive video system comprising:

an output display area arranged to display a graphical image;

an image capturing device arranged to capture a video comprised of a sequence of frames;

a processing system comprising:
a motion detecting algorithm arranged to compare each frame of the captured video to a previous frame of the captured video and generate according to prescribed criteria a respective difference map comprising identified areas of change in the frame relative to the previous frame; and
an image generating algorithm arranged to alter the graphical image displayed on the output display area in response to the identified areas of change of the difference maps; and

a user interface comprising:
a controller display area arranged to display a visual representation of the difference map; and
a user input arranged to adjust the prescribed criteria used to generate the difference map.

The visual representation of the motion event map provides a tool which allows any average person to recognize the effect of various adjustments to the criteria of the motion detecting algorithm. The resulting feedback provided to a user calibrating the interactive video system to the surrounding environment allows users of various skill levels to set up the system easily using conventional computer equipment of relatively low cost. Accordingly the interactive video system of the present invention is well suited to be set up in various environments which were previously unsuitable for prior art interactive video systems.

Preferably each frame is comprised of pixels and wherein the motion detecting algorithm is arranged to:

compare the pixels of each frame to the pixels of the previous frame to generate a difference map indicating pixels which have changed; and

generate the motion event map using pixels which have changed as indicated by the difference map to define the identified motion events.

In one embodiment, the prescribed criteria of the motion detecting algorithm includes a Gaussian blurring function arranged to be applied by the processing system to the difference map to produce the motion event map such that adjustment of the Gaussian blurring function through the user input affects a sensitivity of the motion detecting algorithm to motion.

Preferably the motion detecting algorithm is arranged to group adjacent pixels which have changed in the difference map to define the motion events such that each motion event represents a group of changed pixels.

The image generating algorithm may be arranged to alter the graphical image according to a size of the motion events, the location of the motion events, or both.

In preferred embodiments there is provided a primary display locating the output display area thereon and an auxiliary display separate from the primary display which locates the controller display area thereon. The auxiliary display may be arranged to visually represent the video of the image capturing device thereon separately from the motion event map.

Preferably he user interface includes a scene selection tool arranged to select one graphical image to be displayed on the output display area from a plurality of graphical images stored on an associated memory of the processing system.

Preferably the user interface includes a camera selection tool arranged to select one image capturing device to capture said video among a plurality of image capturing devices arranged to be associated with the processing system.

The motion detecting system is preferably operable in a first camera orientation mode in which a normal orientation of the video is used to generate the difference map and a second camera orientation mode in which a mirror image of the video relative to the normal orientation is used to generate the difference map. In this instance, the user interface preferably includes a camera orientation selection tool arranged to allow a user to select between the first and second camera orientation modes through the user interface.

In one embodiment, the image capturing device comprises a web camera including an adjustable brightness control, the brightness control being visually represented on the user interface and being adjustable through the user input. Preferably an adjustable contrast control is also arranged to be visually represented on the user interface and adjustable through the user input.

When using a web camera, the user interface may also include a boundary control arranged to select a designated portion of the frames of the video to be compared by the motion detecting algorithm in which the boundary control is adjustable through said user input.

In an alternative embodiment, the image capturing device may comprise any suitable camera or combination of cameras, for example an infrared camera or a stereoscopic camera, which is arranged to capture a depth field such that each frame is comprised of pixels and each pixel represents a distance of a represented object in the surrounding environment from the image capturing device.

In this instance, the image capturing device is preferably arranged to only represent distance to represented objects which are within a prescribed range of depths. The prescribed criteria of the motion detecting algorithm preferably includes said prescribed range of depths such that the prescribed range of depths is adjustable through the user interface.

The prescribed criteria may also include a depth sensitivity threshold, wherein each frame is comprised of pixels, and wherein the motion detecting algorithm is arranged to:

compare the pixels of each frame to the pixels of the previous frame to generate a difference map indicating pixels which have changed by a distance which is greater than the depth sensitivity threshold; and

generate the motion event map using pixels which have changed as indicated by the difference map to define the identified motion events.

Preferably the depth sensitivity threshold is adjustable through the user interface.

The prescribed criteria of the motion detecting algorithm may also include a size threshold, wherein each frame is comprised of pixels, and wherein the motion detecting algorithm is arranged to:

compare the pixels of each frame to the pixels of the previous frame to generate a difference map indicating pixels which have changed;

group adjacent pixels which have changed in the difference map into respective groups of changed pixels;

discard groups of changed pixels which are smaller than the size threshold; and

generate the motion event map such that each motion event is defined by a respective one of the groups of changed pixels which is greater than the size threshold.

Preferably the size threshold is also adjustable through the user interface.

According to a second aspect of the present invention there is provided an interactive video system comprising:

an output display area arranged to display a graphical image;

an image capturing device arranged to capture a video comprised of a sequence of frames in which each frame comprises a plurality of pixels;

a processing system comprising:
a motion detecting algorithm arranged to i) compare the pixels of each frame of the captured video to the pixels of a previous frame of the captured video to generate a difference map indicating pixels which have changed, ii) group adjacent pixels which have changed in the difference map into respective groups of changed pixels, and ii) generate a motion event map comprising identified motion events such that each motion event is defined by a respective one of the groups of changed pixels; and
an image generating algorithm arranged to alter the graphical image displayed on the output display area according to a size, a location, or both size and location of the motion events of the motion event map; and

a user interface comprising:
a controller display area arranged to display a visual representation of the motion event map; and
a user input arranged to adjust the prescribed criteria used to generate the motion events in the motion event map such that adjustment through the user input affects a sensitivity of the motion detecting algorithm to motion.

The system may further include a primary display locating the output display area thereon and an auxiliary display separate from the primary display which locates the controller display area and the user input thereon such that the visual representation of the motion event map and a visual representation of the adjustable prescribed criteria are arranged to be displayed thereon.

Various embodiments of the invention will now be described in conjunction with the accompanying drawings in which:

### BRIEF DESCRIPTION OF THE DRAWINGS

FIG. 1 is schematic representation of a first configuration of the components of the interactive video system.

FIGS. 2a through 2d are schematic representations of alternative configurations of the interactive video system.

FIG. 3 is a flow chart illustrating initial installation of the interactive video system on a computer.

FIG. 4 is a flow chart illustrating the loading of a graphical image to be displayed by the interactive video system.

FIG. 5 is a schematic representation of the user interface when using a first embodiment of the image capturing device.

FIG. 6 is a schematic representation of a second embodiment of the image capturing device together with the associated user interface.

FIG. 7 and FIG. 8 are schematic representations of the motion detecting algorithm according to the first embodiment using different settings for the prescribed criteria of the algorithm.

FIG. 9 is a schematic representation of the motion detecting algorithm according to the second embodiment.

In the drawings like characters of reference indicate corresponding parts in the different figures.

### DETAILED DESCRIPTION

Referring to the accompanying figures there is illustrated an interactive video system generally indicated by reference numeral 10. Although various embodiments of the system are described and illustrated herein, the common features will first be described.

The system 10 generally comprises an output display area 12 such as a primary display surface in the form of a video screen, a screen onto which an image is projected, or any other surface onto which an image can be projected from a projector 13 such as a wall or a floor. The output display area is generally located adjacent to a surrounding environment locating users 15 therein which interact with the graphical images being displayed on the output display area.

The system 10 further includes an image capturing device 14, typically in the form of a camera arranged to capture video images of the users in the environment adjacent the output display area to which the graphical display image is displayed. In further instances, the image capturing device may be arranged to capture video of any moving objects within a target area. In either instance, the video captured comprises a sequence of frames 17 in which each frame is comprised of a two dimensional array of pixels.

The system 10 further includes a processing system 16 for example a personal computer or lap top having a processor therein so as to be arranged to execute various algorithms stored on the associated memory of the processor. Among the algorithms is a motion detecting algorithm which receives the video from the image capturing device and compares adjacent frames of video in the sequence according to prescribed criteria in order to determine where within the two dimensional array and how much motion is occurring at any given time. The motion detecting algorithm detects motion for each frame relative to a previous frame in real time as the video is captured.

The processing system also includes an image generating algorithm which produces the graphical image to be displayed on the output display area. More particularly, the image generating algorithm alters a graphical image being displayed in response to the amount (or size) and location of motion detected within the video frames.

The system further includes a graphical user interface displayed on a controller display area. The controller display area 18 is typically provided in the form of an auxiliary display separate from the primary display locating the output display area thereon, for example the monitor associated with the personal computer or laptop on which the algorithms of the present invention are executed. The user interface permits interaction with an operator of the system through a user input 20, typically in the form of input controls on the computer. The user interface allows the various criteria of the motion detecting algorithm to be visually represented on the controller display area such that the user can readily adjust the criteria through the user input and effectively adjust the sensitivity of the interactive video system 10 to motion for calibrating the system to the surrounding environment.

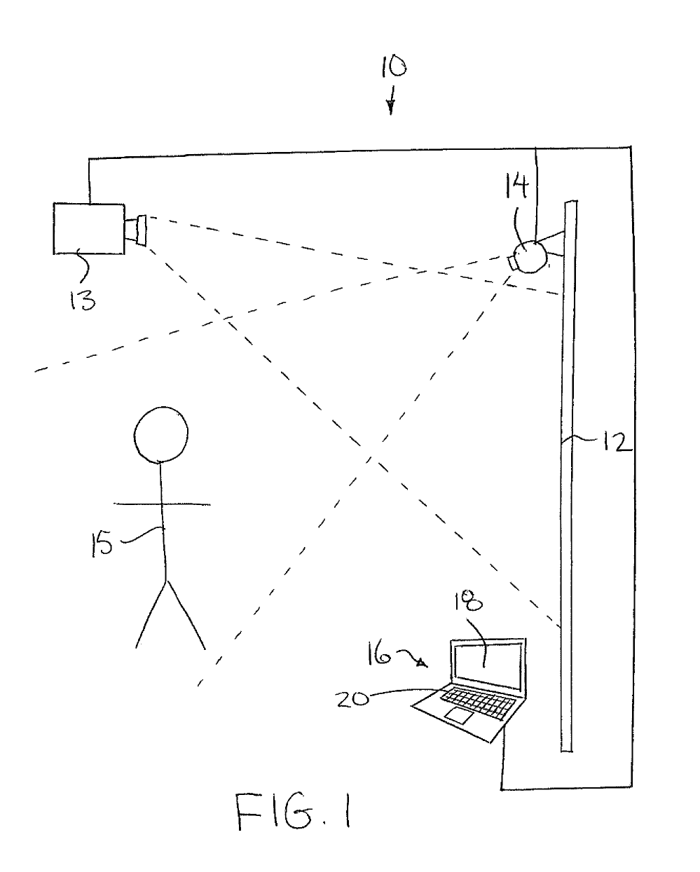

As shown in FIG. 1, according to a first configuration, the system 10 may be implemented within a room which locates the output display area along one side wall of the room while the camera is located above the output display area so as to be directed an opposing wall of the room and in an opposing direction to a projector which projects the image onto the output display area. This configuration ensures that the graphical image displayed on the output display area does not form part of the frames of video captured by the camera.

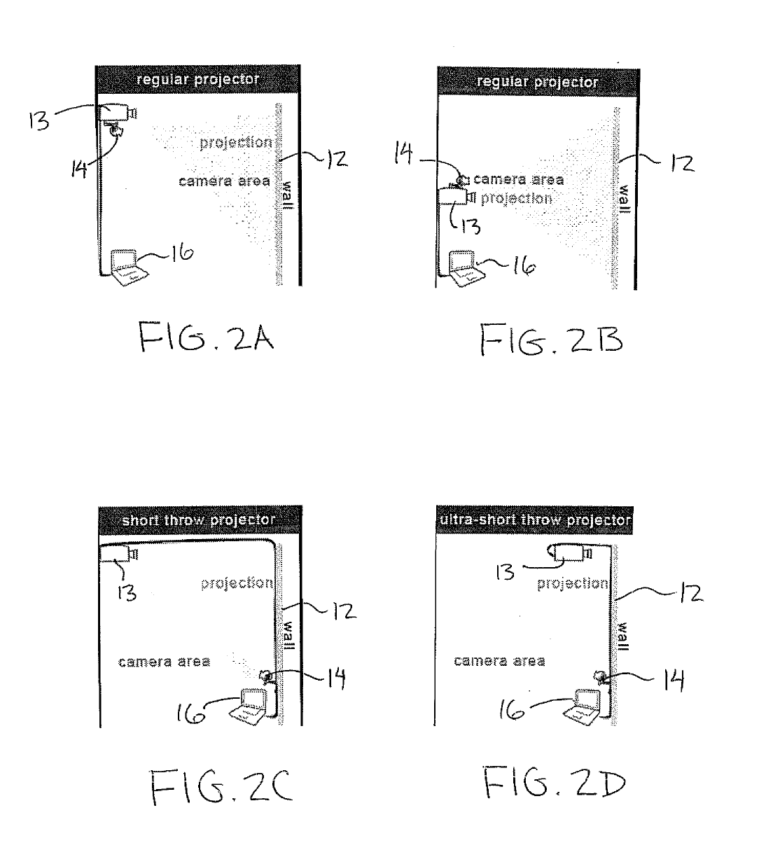

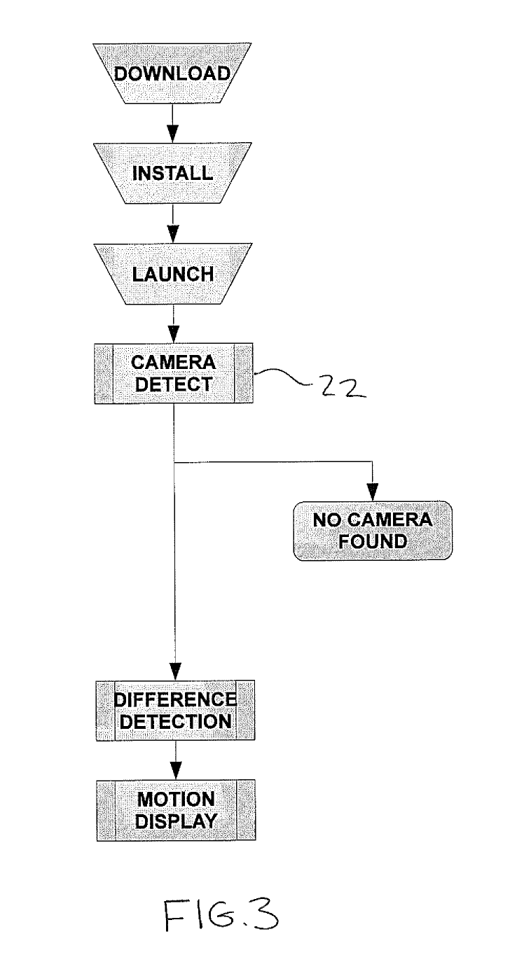

In an alternative configuration as shown in FIG. 2c, the camera may be oriented towards the opposing wall relative to the projector displaying the graphical image, however in this instance the camera may be mounted adjacent to the floor or at a location below the output display area while being similarly directed towards the opposing wall of the room. In yet a further configuration the projector may be mounted in close proximity to the surface locating the output display area thereon by either locating a short throw projector or an ultra short throw projector as shown in FIGS. 2c and 2d. In all of the embodiments of FIGS. 1, 2c and 2d, the camera is located adjacent to the output display area and is directed outwardly from the display surface in a one orientation mode.

Alternatively, the camera and the projector may be located in proximity to one another and be commonly directed towards a surface defining the output display area 12. The surface may be a wall or a floor for example. The embodiments of FIGS. 2a and 2b illustrate two examples of camera and projector placement either adjacent to the ceiling spaced above users within the environment, or at an intermediate height so that users are located between the camera and the wall. In both of the embodiments, FIGS. 2a and 2b, the camera is located opposite the output display area and is directed towards the output display area instead of the reverse orientation of the above noted embodiments. In this instance, the camera operates in a different orientation mode as described in further detail below.

Once the camera and output display area have been configured and connected to a suitable processing system, the operator can then further execute the present invention by following the flow chart of FIG. 3. The process begins by obtaining and installing suitable software which defines the motion detecting algorithm and the image generating algorithm together with the user interface. Once the user initiates execution of the programming, the program will initially scan the computer to determine which cameras are connected and a default camera is displayed first in a drop-down menu while the feed from the camera is displayed in a camera display window 21 which forms a portion of the user interface on the auxiliary display of the present invention.

If no camera is detected, the feed remains blank and the user cannot advance to load scenes of graphical images into the associated memory of the processing system. Once the camera is found and the system is operation, the motion detecting algorithm begins comparing and calculating differences from frame to frame in the video feed and interprets the data as motion. The detected motion is visually represented as a motion event map on the user interface in which areas of change from the frame to frame analysis are identified to the user as motion events based on the current camera settings and settings of other prescribed criteria of the motion detecting algorithm.

The detection and selection of a camera associated with the processing system is executed by a camera selection tool 22 which forms part of the algorithms of the processing system of the present invention to allow an operator to select one image capturing device to capture the video stream among a potential plurality of image capturing devices arranged to be associated with the system.

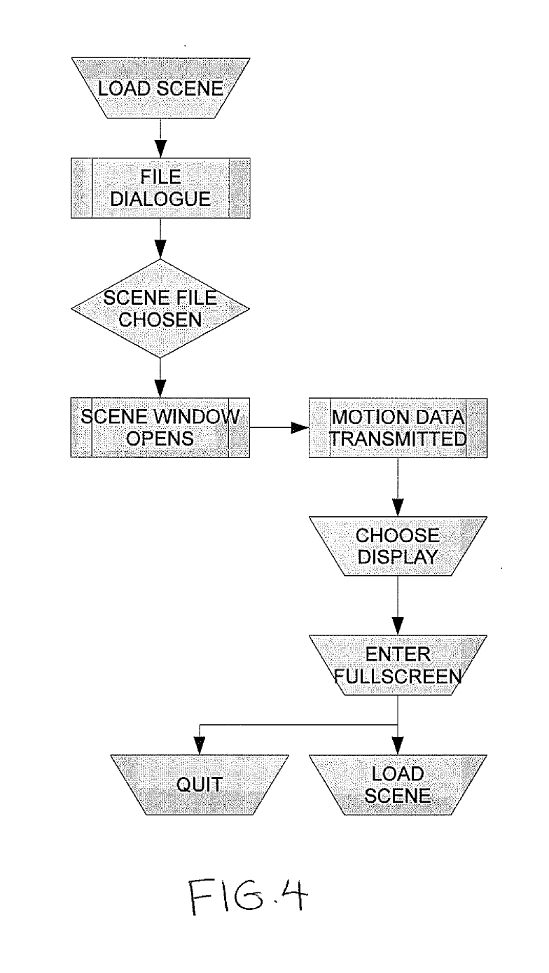

To display graphical images through the image generating algorithm, a user must first follow the steps of FIG. 4 relating to a selection of a scene using a scene selection tool 23 visually represented on the user interface to select one graphical image to be displayed from a potential plurality of graphical images stored on an associated memory of the associated system.

A conventional file dialogue opens the scenes folder and an appropriate scene file is selected from a default location or elsewhere on the computer. Users can activate scenes in full screen mode on the current display or on a secondary display such as a projector or additional monitor by clicking and dragging the scene window to the desired location and pressing “full screen” or clicking “enter”.

The system of the present invention then begins transmitting motion data to the scene loaded in the image generating algorithm. Each scene uses the motion data to effect different elements in each scene and to create different reactions. These can include triggering, following, avoidance and visibility as different techniques of altering the graphic image being displayed on the output display area.

If a secondary monitor such as a secondary projector is used for the scene, the settings panel remains available on the auxiliary monitor of the computer executing the program. A new scene can be loaded by clicking the “load scene” button graphically represented on the user interface for choosing a new scene. When the control panel displayed on the user interface is closed, the program stops. Before quitting, the application saves all current settings of the prescribed criteria or any other adjustable features and loads the settings on the next restart.

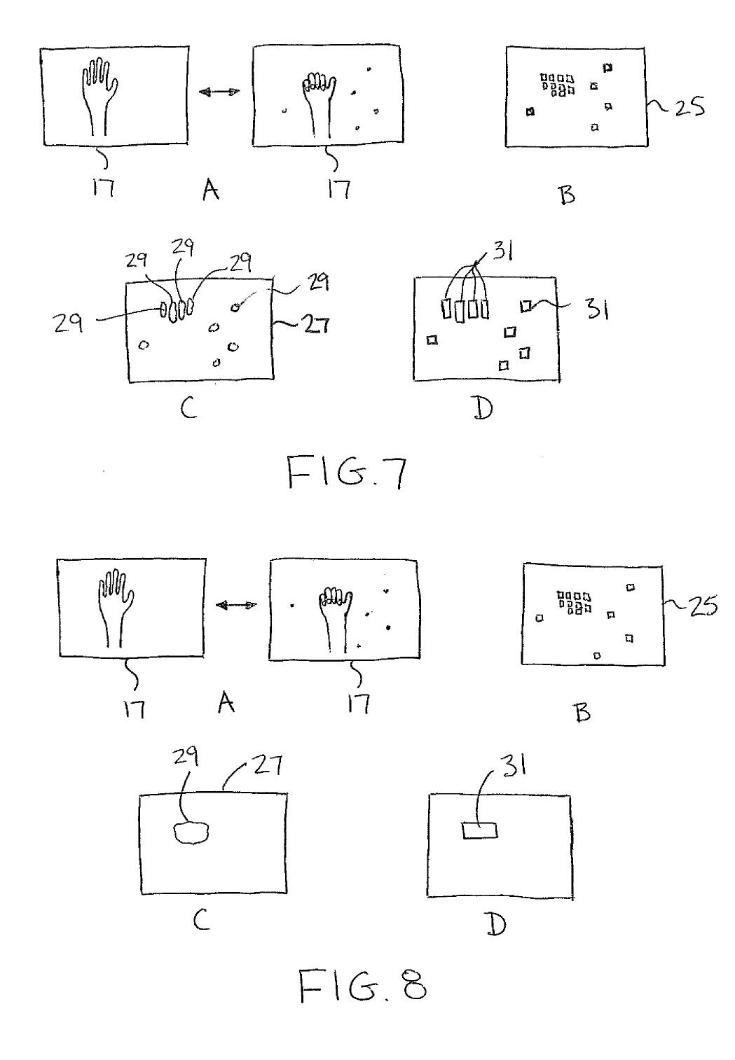

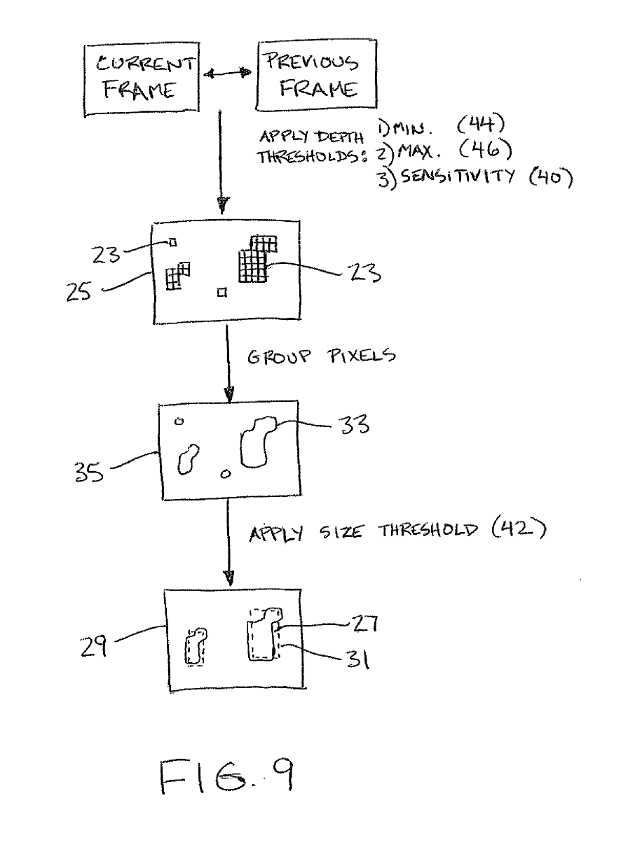

Turning now to FIGS. 7 and 8, details of the motion detecting algorithm according to a first embodiment will now be described in further detail. Although various embodiments of cameras can be used, in either instance a video generally in the form of a series of frames 17 are fed to the motion detecting algorithm with each frame comprising a two dimensional array of pixels. The function of the motion detecting algorithm operates by initially comparing each frame 17 of the captured video to a previous frame of the captured video as shown in step A to produce a difference map 25 as shown in step B. In the difference map 25, each highlighted pixel represents a pixel of the current video frame which has changed relative to the previous frame.

When the motion detecting algorithm is operable in a first camera orientation mode as in FIGS. 2a and 2b, a normal orientation of the video is used to generate the motion event map and the subsequent motion event map as described below. Alternatively in a second camera orientation mode as shown in FIGS. 1, 2c and 2d, a mirror image of the video relative to the normal orientation is used to generate the motion event map due to the projector and the camera being oriented in opposing directions. The user interface includes a camera orientation selection tool 26 visually represented on the controller display area which allows a user to select through the user input between the first and second camera orientation modes. The camera orientation selection tool is typically just toggled on and off to select between the first and second modes.

Once the difference map has been generated in step B of FIGS. 7 and 8, the motion detecting algorithm applies a Gaussian blurring function as one of the prescribed criteria of the algorithm to produce a motion event map 27 which identifies areas of change 29 within each frame 17 of video relative to the previous frame. The Gaussian blurring function applies a smoothing function to the difference map 25 which allows for: i) grouping proximal pixels indicating change into common identified areas of change or blobs 29; and ii) eliminating individual or smaller groupings of pixels by blending them into the surrounding pixels which do not indicate a change between the frames depending upon the sensitivity setting of the blurring function.

Once areas of change 29 have been identified in the motion event map 27, the motion detecting algorithm defines each identified area of change 29 formed by a group of adjacent pixels as a motion event. The motion events are represented as respective rectangles 31 when input into the image generating algorithm which alters the graphical image displayed according to the motion events. More particularly, the motion events are used by the algorithm to define a size and location of the areas of motion within the environment captured by the camera. The image generating algorithm can then alter the graphical image displayed on the output display area according to either the amount of motion represented by the size of the identified areas of change or the location of the motion of the users as identified by the location of the identified areas of change within the two dimensional pixel array.

The differences between steps C and D in FIGS. 7 and 8 are the result of different settings being used for the input values applied by the Gaussian blurring function which affects the degree of smoothing of the pixels indicating change in the difference map when producing the motion event map 27. This affects to what degree adjacent pixels indicating change in the difference map 25 are grouped together into common identified areas of change 29 in the motion event map 27.

In the illustrated embodiment where a user with extended fingers forms a fist by folding their fingers forwardly and inwardly towards the camera, the difference map initially identifies several pixels in Steps A and B which change resulting from the motion of each finger. According to a first setting of the prescribed criteria of the Gaussian function of the motion detecting algorithm shown in FIG. 7, the motion detected by each individual finger is identified as its own identified area of change 29 within the motion event map 27. Also minor changes in lighting or other smaller background motions may also be represented as other areas of change 29. The subsequent rectangles used to identify the identified areas of change are numerous and smaller than in the instance of FIG. 8.

In FIG. 8, a second setting of the blurring function is used such that the blurring function causes all of the proximal pixels indicating change in the difference map 25 to be blended together and commonly grouped as a single identified area of change 29. The smaller pixels which are not in proximity to the larger grouping of adjacent pixels forming the area of change 29 are blended into the background and are no longer represented as areas of change in the motion event map 27. There is thus only a single motion event 29 in this instance which is represented by a single rectangle 31 output from the motion detecting algorithm and input into the image generating algorithm to determine how the graphical image should be altered in response to the identified areas of change or motion events 29.

While the second setting is simpler and quicker to execute by the processing system due to a single identified area of change instead of several, this setting results in less sensitivity to smaller individual motions. The reduced sensitivity is advantageous when the smaller individual motions would otherwise be so numerous that the processing speed of the system is noticeably reduced. Depending upon the type of motion expected in the surrounding environment to which the image capturing device is directed, the user can adjust the prescribed criteria through the user interface visually represented on the controller display area.

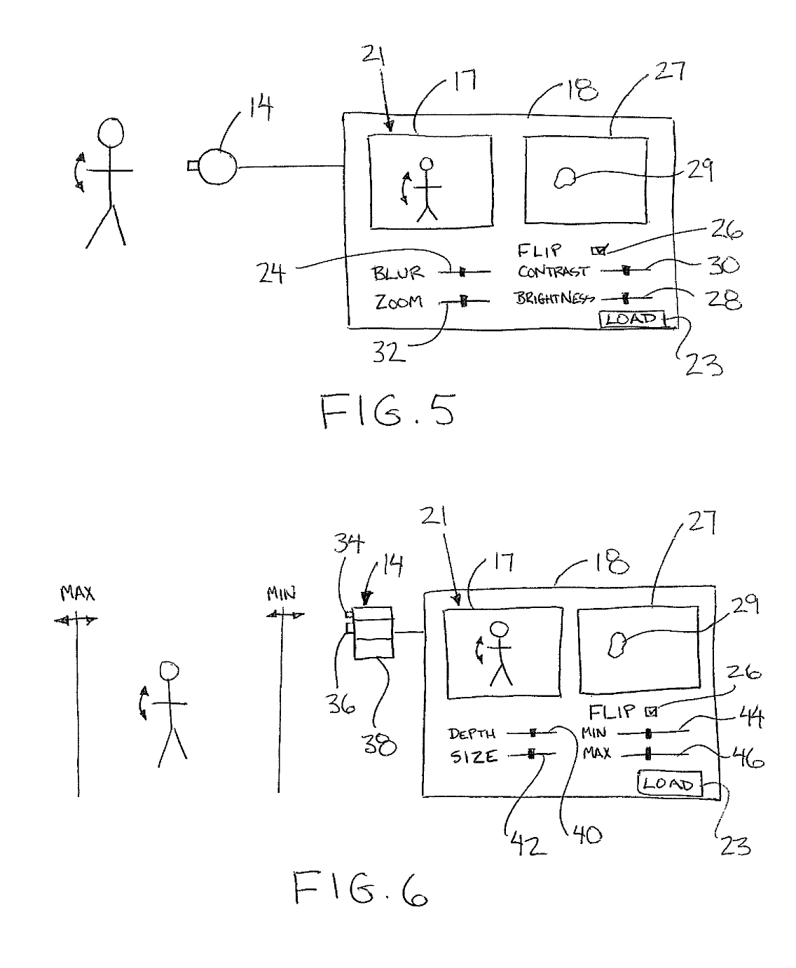

In both embodiments of FIGS. 5 and 6, the user interface includes a visual representation of the motion event map 27 displayed on the controller display area, adjacent to the captured frames of video from the image capturing device. A visual representation of the setting of the sensitivity function and any other criteria used to generate the motion event map are also displayed on the controller display area in each instance, despite the criteria for the two embodiments being different from one another. A typical visual representation of the criteria includes a scale, a slider bar or other similar tool to indicate one setting among a range of possible settings from which the selection of each criterion can be made.

Turning now more particularly to the embodiment of FIG. 5, in this instance, the image capturing device comprises a conventional web camera producing frames which are a visual representation in two dimensions of the target area. The video is displayed in real time on the controller display area, and for each frame the motion detecting algorithm calculates the motion event map and displays the motion event map adjacent the corresponding video frame, also in real time. Adjustable criteria which effects the calculation of the motion event map includes the blur function 24, to adjust the Gaussian blurring function, the flip function 26 for selecting the camera orientation, a brightness control 28 for adjusting brightness of the captured video, a contrast control for adjusting the contrast of the captured video from the camera, and a zoom function 32.

The zoom function generally comprises a boundary control which is adjustable through the user interface such that only a selected designated portion of each frame of video may be used by the motion detecting algorithm for detecting motion. The boundary tool thus functions for cropping the frames of video to concentrate only on one portion of the target area versus another or versus the whole. This can also be accomplished simply by controlling a zoom function of the lens on the web camera to adjust the size and location of the video frames being captured and compared by the motion detecting algorithm.

The brightness and contrast controls typically comprise existing adjustments associated with the web camera, but which are reproduced and visually represented on the controller display area with the other criteria to allow an operator access for adjusting these criteria commonly with the other adjustable criteria instead of requiring a separate interface for adjusting these aspects of the camera. Adjustment of any one of the above noted criteria will affect either the quality of the video frames captured by the camera or the manner in which calculations are performed in comparing adjacent frames by the motion detecting algorithm such that each of the criteria settings has an affect on how the motion event map is generated which in turn affects the sensitivity of the system to motion.

Turning now to the embodiment of FIG. 6, in this instance the image capturing device may comprise an infrared camera or any other camera arrangement suitable of capturing frames of video together with a depth field such that each frame is comprised of pixels and each pixel represents a distance to a represented object in the surrounding environment from the image capturing device.

The infrared camera of the illustrated embodiment generally comprises an infrared light source 34, a lens 36, and a processing sub-system 38. The infrared light source effectively projects infrared light into the target area or surrounding environment adjacent the output display area, for example in a grid pattern. The lens 36 captures the infrared light reflected back from objects in the target environment such that the processing system can analyse the captured array and define a 3-D shape of objects within the target environment by studying how the grid pattern of projected infrared light is altered in its reflective state captured by the lens 36.

The three dimensional data for each frame of video is presented as a two dimensional array of pixels in which each pixel represents a value among a range of values corresponding to a depth or distance from the lens of the corresponding object represented by that pixel.

The motion detecting algorithm according to the second embodiment of FIG. 6 is represented schematically in FIG. 9. By comparing corresponding pixels of each frame of video from the image capturing device to a previous frame, the motion detecting algorithm in this instance is similarly arranged to determine which pixels have changed to produce the difference map 25 described above.

The adjustable criteria used by the motion detecting algorithm to produce the difference map and the subsequent motion event map in this embodiment include a depth sensitivity threshold 40, a motion sensitivity threshold 42, a minimum depth threshold 44, and a maximum depth threshold 46. As in the previous embodiment, these criteria are visually represented on the user interface as shown in FIG. 6.

The minimum depth and maximum depth correspond to minimum and maximum distances from the camera lens which the camera measures as a depth to be recorded in the two dimensional depth fields of pixels defining the video frames 17 captured by the camera. These minimum and maximum distances can be adjusted by the user to define the boundaries within the surrounding environment locating the users therein where motion is being assessed. The processing sub-system 38 of the camera is thus arranged to only represent distance to objects from the surrounding environment in the frames which are within the prescribed range of depths defined by the minimum and maximum depth settings. The minimum and maximum depth thresholds define a prescribed range of depths which is adjustable through the user interface such that the image capturing device is arranged to only represent distance to objects in the captured environment which are within the prescribed range of depths.

In the second embodiment, the motion detecting algorithm builds each pixel of the difference map 25 as follows. Firstly the algorithm considers if the pixel of the relevant video frame and the corresponding pixel within the previous video frame are within the prescribed range of depths by applying the minimum and maximum depth thresholds. Pixels of the video frames outside of the prescribed range of depth have zero depth when comparing corresponding pixels to assess if there is a difference between one frame and the previous frame

Secondly the algorithm considers if the difference between the pixel of the relevant video frame and the corresponding pixel of the previous video frame exceeds a depth sensitivity threshold. When comparing the pixels of each frame to the pixels of the previous frame to generate the difference map, pixels which have changed by a distance which is greater than the depth sensitivity threshold are represented as motion indicating pixels 23 on the difference map. Alternatively, pixels which have not changed by a distance which is greater than the depth sensitivity threshold are represented as pixels having no change and thus no motion. The depth sensitivity threshold 40 thus relates to the amount of difference in depth required between each pixel of one frame and the corresponding pixel of the previous frame in order to determine if motion or change has occurred at that pixel location.

Once the difference map 25 of a respective video frame has been generated by comparison to the previous video frame, the difference map is used to generate the motion event map 27 in which motion events 29 are defined. This is typically accomplished in two steps. Firstly the pixels 23 indicating change are grouped together into respective groups of changed pixels otherwise referred to as blobs 33 within a blob map 35. Secondly the motion sensitivity threshold 42 of the motion detecting algorithm, which is also adjustable through the user interface, is applied. The motion sensitivity threshold 42 is effectively a size threshold such that only groups of pixels or blobs 33 which exceed the threshold are recorded as motion events 27 in the motion event map 29. Groups of pixels or blobs 33 which are smaller than the size threshold are effectively discarded and no longer considered as motion as shown in FIG. 9. Accordingly when the motion event map 29 is generated, each resulting motion event 27 is defined by a respective one of the groups of changed pixels which is greater than the size threshold. Finally, as in the previous embodiment, each motion event 27 is represented and defined as a respective rectangle 31 for input into the image generating algorithm. The rectangles can also be used to visually represent the motion events in the motion event map within the controller display area.

As in the previous embodiment, all of the adjustable criteria used in producing the motion event map visually represented on the user interface are also visually represented so that the operator can clearly see what each criterion setting is within its respective scale of possible settings. In addition to having a visual representation of the current settings, the visual representation of the motion event map 27 on the user interface allows a user to immediately see the effects of each changing criteria in terms of how motion is detected. The system 10 is thus able to be readily calibrated by operators with minimal technical knowledge regardless of the environment where the interactive video system is to be set up and used.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. An interactive video system comprising:
an output display area arranged to display a graphical image;
an image capturing device arranged to capture a video comprised of a sequence of frames;
a processing system comprising:
a motion detecting algorithm arranged to compare each frame of the captured video to a previous frame of the captured video and generate according to prescribed criteria a respective motion event map comprising identified motion events representing areas of change in the frame relative to the previous frame; and
an image generating algorithm arranged to alter the graphical image displayed on the output display area in response to the identified motion events of the motion event maps; and
a user interface comprising:
a controller display area arranged to display a visual representation of the motion event map; and
a user input arranged to adjust the prescribed criteria used to generate the motion event map.

2. The system according to claim 1 wherein each frame is comprised of pixels and wherein the motion detecting algorithm is arranged to:
compare the pixels of each frame to the pixels of the previous frame to generate a difference map indicating pixels which have changed; and
generate the motion event map using pixels which have changed as indicated by the difference map to define the identified motion events.

3. The system according to claim 2 wherein the prescribed criteria of the motion detecting algorithm includes a Gaussian blurring function arranged to be applied by the processing system to the difference map to produce the motion event map such that adjustment of the Gaussian blurring function through the user input affects a sensitivity of the motion detecting algorithm to motion.

4. The system according to claim 2 wherein the motion detecting algorithm is arranged to group adjacent pixels which have changed in the difference map to define the motion events such that each motion event represents a group of changed pixels.

5. The system according to claim 1 wherein the image generating algorithm is arranged to alter the graphical image according to a size of the motion events.

6. The system according to claim 1 wherein the image generating algorithm is arranged to alter the graphical image according to a location of the motion events.

7. The system according to claim 1 further comprising a primary display locating the output display area thereon and an auxiliary display separate from the primary display which locates the controller display area thereon.

8. The system according to claim 7 wherein the auxiliary display is arranged to visually represent the video of the image capturing device thereon separately from the motion event map.

9. The system according to claim 1 wherein the user interface includes a scene selection tool arranged to select one graphical image to be displayed on the output display area from a plurality of graphical images stored on an associated memory of the processing system.

10. The system according to claim 1 wherein the user interface includes a camera selection tool arranged to select one image capturing device to capture said video among a plurality of image capturing devices arranged to be associated with the processing system.

11. The system according to claim 1 wherein the motion detecting system is operable in a first camera orientation mode in which a normal orientation of the video is used to generate the difference map and a second camera orientation mode in which a mirror image of the video relative to the normal orientation is used to generate the difference map.

12. The system according to claim 11 wherein the user interface includes a camera orientation selection tool arranged to allow a user to select between the first and second camera orientation modes through the user interface.

13. The system according to claim 1 wherein the image capturing device comprises a web camera including an adjustable brightness control, the brightness control being visually represented on the user interface and being adjustable through the user input.

14. The system according to claim 1 wherein the image capturing device comprises a web camera including an adjustable contrast control, the contrast control being visually represented on the user interface and being adjustable through the user input.

15. The system according to claim 1 wherein the image capturing device comprises a web camera and wherein the user interface includes a boundary control arranged to select a designated portion of the frames of the video to be compared by the motion detecting algorithm, the boundary control being adjustable through said user input.

16. The system according to claim 1 wherein the image capturing device is arranged to capture a depth field such that each frame is comprised of pixels and each pixel represents a distance of a represented object in the surrounding environment from the image capturing device.

17. The system according to claim 16 wherein the image capturing device is arranged to only represent distance to represented objects which are within a prescribed range of depths and wherein the prescribed criteria of the motion detecting algorithm includes said prescribed range of depths such that the prescribed range of depths is adjustable through the user interface.

18. The system according to claim 16 wherein the prescribed criteria includes a depth sensitivity threshold, wherein each frame is comprised of pixels, and wherein the motion detecting algorithm is arranged to:
compare the pixels of each frame to the pixels of the previous frame to generate a difference map indicating pixels which have changed by a distance which is greater than the depth sensitivity threshold; and
generate the motion event map using pixels which have changed as indicated by the difference map to define the identified motion events;
the depth sensitivity threshold being adjustable through the user interface.

19. The system according to claim 1 wherein the prescribed criteria of the motion detecting algorithm includes a size threshold, wherein each frame is comprised of pixels, and wherein the motion detecting algorithm is arranged to:
compare the pixels of each frame to the pixels of the previous frame to generate a difference map indicating pixels which have changed;
group adjacent pixels which have changed in the difference map into respective groups of changed pixels;
discard groups of changed pixels which are smaller than the size threshold; and
generate the motion event map such that each motion event is defined by a respective one of the groups of changed pixels which is greater than the size threshold;
the size threshold being adjustable through the user interface.

20. An interactive video system comprising:
an output display area arranged to display a graphical image;
an image capturing device arranged to capture a video comprised of a sequence of frames in which each frame comprises a plurality of pixels;
a processing system comprising:
a motion detecting algorithm arranged to i) compare the pixels of each frame of the captured video to the pixels of a previous frame of the captured video to generate a difference map indicating pixels which have changed, ii) group adjacent pixels which have changed in the difference map into respective groups of changed pixels, and ii) generate a motion event map comprising identified motion events such that each motion event is defined by a respective one of the groups of changed pixels; and
an image generating algorithm arranged to alter the graphical image displayed on the output display area according to a size, a location, or both size and location of the motion events of the motion event map; and
a user interface comprising:
a controller display area arranged to display a visual representation of the motion event map; and
a user input arranged to adjust the prescribed criteria used to generate the motion events in the motion event map such that adjustment through the user input affects a sensitivity of the motion detecting algorithm to motion.
